(19) United States
(12) Patent Application Publication
(10) Pub. No.: US 2008/0095515 A1
(43) Pub. Date: Apr. 24, 2008

(54) Contents Character Information Acquisition Method, Contents Character Information Acquisition Program, Contents Character Information Acquisition Apparatus, and Video Content Recording Apparatus

(76) Inventor: Masaru MIYAMOTO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/876,293

(22) Filed: Oct. 22, 2007

(30) Foreign Application Priority Data
Oct. 24, 2006 (JP) P2006-289028

(51) Int. Cl. H04N 5/91

(52) U.S. Cl. 386/95

(57) ABSTRACT

The present invention provides a contents character information acquisition method including the steps of extracting content feature information indicative of an image making up video content in accordance with a predetermined extraction algorithm, detecting, from a database in which given-image feature information extracted from a given image in accordance with the extraction algorithm is related with image text information indicative of contents of the given image, the given-image feature information that is similar to the content feature information, and acquiring, as contents character information indicative of the contents of the image from which the content feature information has been extracted, the image text information related with the given-image feature information detected in the detection step from the database.

### CROSS REFERENCES TO RELATED APPLICATIONS

The present invention contains subject matter related to Japanese Patent Application JP 2006-289028 filed in the Japanese Patent Office on Oct. 24, 2006, the entire contents of which being incorporated herein by reference.

### BACKGROUND OF THE INVENTION

1. Field of the Invention

The present invention relates to a contents character information acquisition method, a contents character information acquisition program, a contents character information acquisition apparatus, and a video content recording apparatus that are configured to acquire the character information about the contents indicative of the contents of video content.

2. Description of the Related Art

Related-art hard disk recorders are configured to not only record television broadcast programs but also automatically generate a management list for managing these television broadcast programs to register the text information indicative of titles and contents, for example, into that management list, thereby using the management list for the list display of broadcast programs and the searching for these programs.

These hard disk recorders are also configured to get, as text information, EPG (Electric Program Guide) information indicative of the distribution schedules, titles, and contents of television broadcast programs from broadcast signals distributed in terrestrial digital broadcasting, for example.

Some of the above-mentioned hard disk recorders are configured to get the text information of streaming content for the purpose of registering streaming content distributed via the Internet for example into a management list for use for searching (as disclosed in Japanese Patent Laid-open No. 2003-36259, for example).

### SUMMARY OF THE INVENTION

It should be noted that hard disk recorders are configured to record, as video content, not only terrestrial digital broadcast programs and streaming content but also private content such as imaged data taken by a video camera and edited data obtained by an editing task by the user on his own. However, these private data are not attached with text information indicative of titles and contents, for example, so that it is difficult for the related-art hard disk recorders to get the text information indicative of the contents of private data.

Therefore, the present invention addresses the above-identified and other problems associated with related-art methods and apparatuses and solves the addressed problems by providing a contents character information acquisition method, a contents character information acquisition program, a contents character information acquisition apparatus, and a video content recording apparatus that are configured to acquire the character information about the contents indicative of the contents of video content.

In carrying out the invention and according to one aspect thereof, there is provided a contents character information acquisition method. This method is made up of the steps of: extracting content feature information indicative of an image making up video content in accordance with a predetermined extraction algorithm; detecting, from a database in which given-image feature information extracted from a given image in accordance with the extraction algorithm is related with image text information indicative of contents of the given image, the given-image feature information that is similar to the content feature information; and acquiring, as contents character information indicative of the contents of the image from which the content feature information has been extracted, the image text information related with the given-image feature information detected in the detection step from the database.

Consequently, the contents character information indicative of each image making up video content can be acquired from a database.

In carrying out the invention and according to another aspect thereof, there is provided a video content recording apparatus. This apparatus is made up of a recorder configured to record video content supplied from an external apparatus; a feature information extractor configured to extract content feature information indicative of an image making up video content in accordance with a predetermined extraction algorithm; a feature information detector configured to detect, from a database in which given-image feature information extracted from a given image in accordance with the extraction algorithm is related with image text information indicative of contents of the given image, the given-image feature information that is similar to the content feature information; a text acquirer configured to acquire, as contents character information indicative of the contents of the image from which the content feature information has been extracted, the image text information related with the given-image feature information detected by the feature information detector from the database.

Consequently, the contents character information indicative of each image making up video content can be acquired from a database.

As described and according to the invention, contents character information indicative of the contents of each image making up video content can be acquired from a database, thereby realizing a contents character information acquisition method, a contents character information acquisition program, a contents character information acquisition apparatus, and a video content recording apparatus that are configured to acquire content character information indicative of the contents of video content.

### BRIEF DESCRIPTION OF THE DRAWINGS

Other objects and aspects of the invention will become apparent from the following description of embodiments with reference to the accompanying drawings in which:

FIG. 1 is a block diagram illustrating an overall configuration of a hard disk recorder;

FIG. 2 is a block diagram illustrating functional blocks of database generating processing;

FIG. 3 illustrates a text input screen;

FIG. 4 illustrates a keyboard screen;

FIG. 5 illustrates a structure of an image text database;

FIG. 6 is a block diagram illustrating functional blocks of title candidate acquisition processing;

FIG. 7 illustrates a structure of an imaged data management list;

FIGS. 8A and 8B illustrate screens of title candidate texts;

FIG. 9 is a flowchart indicative of image text database generating processing; and

FIG. 10 is a flowchart indicative of title candidate display processing.

### DETAILED DESCRIPTION OF THE PREFERRED EMBODIMENTS

This invention will be described in further detail by way of embodiments thereof with reference to the accompanying drawings.

### (1) Overall Configuration of a Hard Disk Recorder

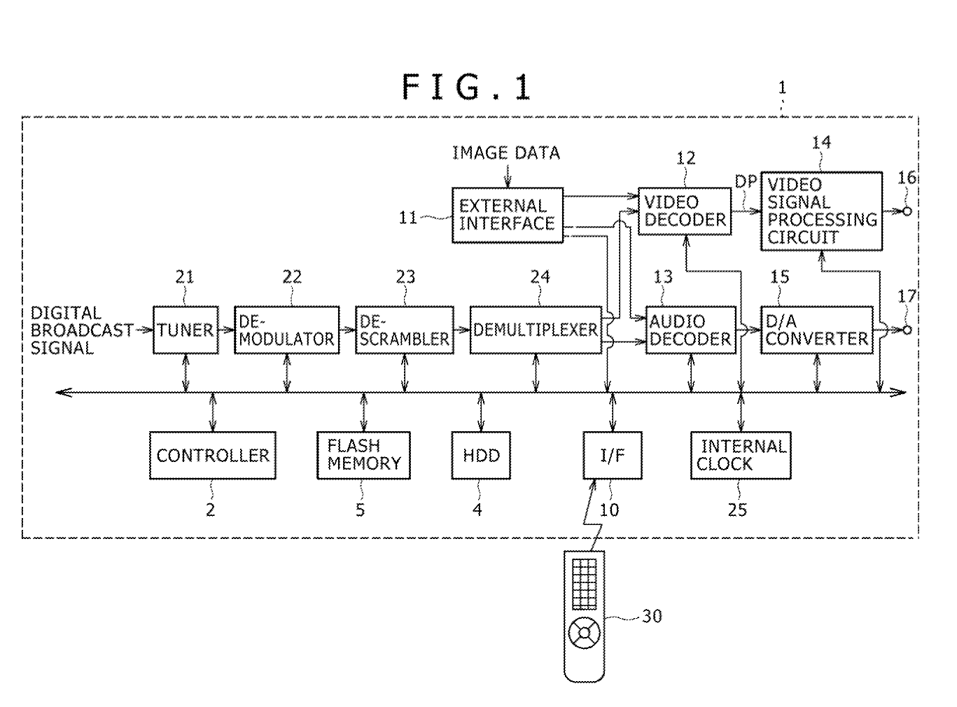

Now, referring to FIG. 1, reference numeral 1 denotes a hard disk recorder as a whole. This hard disk recorder is configured to record imaged data as video content received from a video camera, not shown, and receive and record television broadcast programs carried on terrestrial digital broadcasting.

With this hard disk recorder 1, a controller 2 based on a CPU (Central Processing Unit), a ROM (Read Only Memory), and a RAM (Random Access Memory), each not shown, collectively controls the entire hard disk recorder 1. The controller 2 loads an operating program, a database generating program, and a title candidate display program, for example, from the ROM or a hard disk drive 4 into the RAM, thereby executing the processing based on these programs and text database generating processing and title candidate display processing to be described later.

If requests come from the user through an external remote controller 30, the hard disk recorder 1 gets an operation signal generated by the remote controller 30 through a remote controller interface 10 and supplies the received operation signal to the controller 2.

For example, when an operation signal indicative of a request for recording imaged data held in a video camera, not shown, connected to an external interface 11 is supplied from the remote controller interface 10, the controller 2 executes the processing of recording the received imaged data.

Namely, the controller 2 records the input imaged data entered from a video camera, not shown, via external interface 11 to the hard disk drive 4 as recorded imaged data. At this moment, the controller 2 attaches an imaged data ID made up of a serial number and so on to this recorded image data.

Further, by relating with the imaged data ID, the controller 2 generates an imaged data management list 43 (to be described later) to be recorded to a flash memory 5 by registering imaging date information indicative of a date of imaging and a date of editing, for example, attached to the imaged data and input information indicative of from which input terminal of the external interface 11 the imaged data has been entered.

When an operation signal indicative of a request for reproducing the imaged data recorded to the hard disk drive 4 is supplied from the remote controller interface 10, the controller 2 executes the processing of reproducing the recorded imaged data.

Namely, the controller 2 reads the recorded imaged data specified by the user from the hard disk drive 4 and, at the same time, of the read recorded imaged data, transmits the reproduced video data to a video decoder 12 and the audio data to an audio decoder 13.

The controller 2 decodes the reproduced video data through the video decoder 12 in accordance with a predetermined decoding algorithm, executes digital-to-analog conversion and mixing, for example, on the resultant decoded reproduced video signal DP through a video signal processing circuit 14, and transmits the processed signal to a video output terminal 16. Consequently, the controller 2 displays a video image based on the reproduced video signal DP onto a display monitor, not shown, connected to the video output terminal 16.

In addition, the controller 2 decodes audio data through the audio decoder 13 in accordance with a predetermined decoding algorithm, converts the decoded audio signal into an analog signal through a digital-to-analog converter 15, and transmits the converted signal to an audio output terminal 17. Consequently, the controller 2 can output sound based on this audio data from a loudspeaker, not shown, connected to the audio output terminal 17.

As described above, the hard disk recorder 1 is configured to record and reproduce video content, such as imaged data, entered through the external interface 11.

In addition, when an operation signal indicative of a request for recording a television broadcast program currently on the air is supplied from the remote controller interface 10, the controller 2 receives the specified television broadcast program and, at the same time, executes the processing of recording the received program.

Namely, the controller 2 receives a digital broadcast signal in a selected frequency band through a tuner 21 and transmits the received signal to a demodulator 22. The controller 2 demodulates this digital broadcast signal through the demodulator 22, descrambles the demodulated digital broadcast signal through a descrambler 23, and separates the descrambled signal into broadcast video data, broadcast audio data, and EPG (Electric Program Guide) information packets through a demultiplexer 24. Next, the controller 2 records the broadcast video data and the broadcast audio data to the hard disk drive 4 as a recorded program.

Further, in ending the recording processing, the controller 2 creates a recorded program management list by registering a recording date of each television broadcast program obtained from an internal clock 25, title information about each recorded program extracted from EPG information, and program text information indicative of the contents of each recorded program, and records the generated list to the flash memory 5.

When an operation signal indicative of a request for displaying a list of recorded programs recorded to the hard disk drive 4 is supplied from the remote controller interface 10, the controller 2 reads the recorded program management list from the flash memory 5, generates image data based on this list, and transmits the generated image data to the video decoder 12. As a result, the controller 2 displays a program list based on this recorded program management list onto the display monitor, not shown, by substantially the same processing as the reproduction of recorded imaged data.

Thus, in addition to the recording and reproduction of imaged data entered through the external interface 11, the hard disk recorder 1 records each television broadcast program on the air as a recorded program and, in response to a user request, displays, on the display monitor, a program list including the title information and the like of the recorded program management list on the basis of the recorded program management list automatically generated by use of EPG information.

### (2) Generating an Image Text Database

Because the imaged data entered through the external interface 11 is not attached with the text information indicative of the title and contents of the imaged data as described above, related-art hard disk recorders cannot automatically register, with the imaged data management list 43, such text information as indicative of a title indicative of the contents of recorded imaged data and the contents of imaged data at the stage of the recording of the imaged data.

It should be noted that various technology are generally known in which feature information indicative of a feature or characteristic of each image is extracted from video data such as imaged data and techniques for determining a similarity between images by use of this feature information have been proposed. If two or more images are similar to each other, it is considered that the contents represented by these images are substantially the same, so that, it is highly possible for the text information indicative of the contents of one of these images to also represent the contents of other images.

Therefore, if the hard disk recorder 1 has a database registered with the image text information corresponding to the feature information of images, the hard disk recorder 1 can detect the image similar to the image held in the recorded image data by use of the feature information, thereby using the image text information corresponding to the feature information of the detected image as the contents character information indicative of the contents of the recorded imaged data.

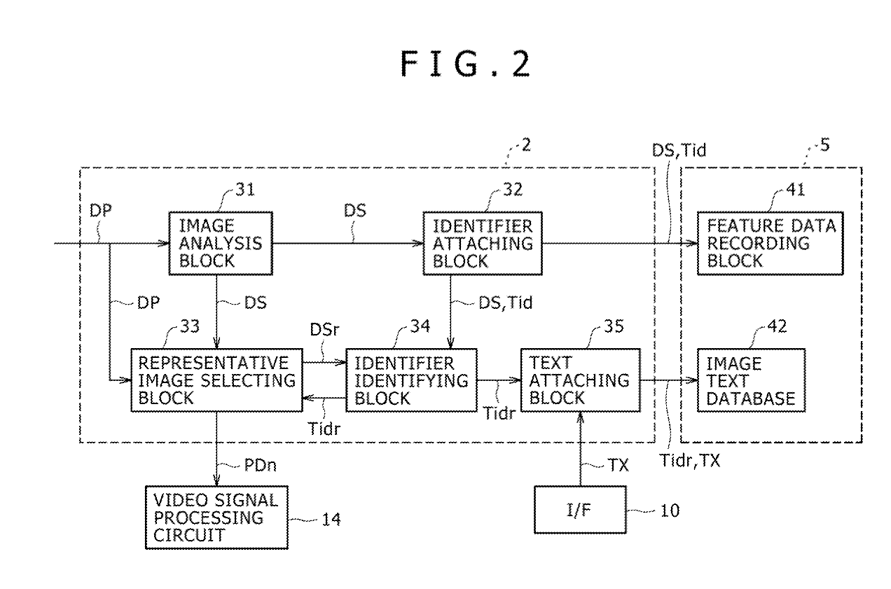

Consequently, the hard disk recorder 1 according to an embodiment of the present invention is configured to generate an image text database 42 in which image text information TX corresponding to the feature information of each image is registered. The following describes the processing of generating this image text database 42. In this database generating processing, the controller 2 of the hard disk recorder 1 is configured to realize functional blocks shown in FIG. 2 by executing a database generating program.

In executing the processing of reproducing the recorded imaged data recorded to the hard disk drive 4 (FIG. 1) for example, the hard disk recorder 1 executes the processing of generating a database concurrently with this reproduction processing.

Namely, the controller 2 of the hard disk recorder 1 supplies a reproduced video signal DP decoded by the video decoder 12 to the video signal processing circuit 14 to display an image based on this reproduced video signal DP onto the display monitor, not shown, and, at the same time, supplies the reproduced video signal DP to an image analysis block 31 and a representative image selecting block 33 in the controller 2.

The image analysis block 31 extracts reproduced video feature data DS from the reproduced video signal DP as the feature information indicative of the feature of each frame image that forms the recorded imaged data and supplies the extracted reproduced video feature data DS to an identifier attaching block 32 and the representative image selecting block 33.

To be more specific, when the reproduced video signal DP is supplied, the image analysis block 31 divides each frame image included in this reproduced video signal DP into 5×5=25 areas for example, and computes a DCT (Discrete Cosine Transform) coefficient of a luminance signal (or a Y signal) for each of these areas. Then, the image analysis block 31 expresses the DCT coefficients for these 25 areas as a 25-degree vector that is the reproduced video feature data DS on a frame image basis.

The identifier attaching block 32 generates a feature information identifier Tid by attaching a serial number for example to the imaged data ID unique to the imaged data and attaches the generated feature information identifier Tid to the reproduced video feature data DS, thereby supplying these reproduced video feature data DS and feature information identifier Tid to a feature data recording block 41 of the flash memory 5 and temporarily recording to the RAM, not shown.

When the reproduced video feature data DS attached with the feature information identifier Tid has been supplied, the feature data recording block 41 records all the reproduced video feature data DS as accumulated feature data DSa in a status in which the feature information identifier Tid is related with the reproduced video feature data DS.

On the other hand, the representative image selecting block 33 selects representative feature data DSr from the reproduced video feature data DS supplied from the image analysis block 31 and transmits the selected data DSr to an identifier identifying block 34.

Namely, the representative image selecting block 33 computes a distance (hereafter referred to a before-behind distance) as a vector between two consecutive pieces of reproduced video feature data DS for example so as to detect a combination of reproduced video feature data DS with this before-behind distance equal to or exceeding a predetermined scene change threshold value.

At this moment, upon detection of a combination of the reproduced video feature data DS with the before-behind distance equal to or exceeding the predetermined scene change threshold value, the representative image selecting block 33 determines that, of the two consecutive pieces of feature data, the frame image on which the succeeding reproduced video feature data DS is based has scene-changed from the frame image on which the preceding reproduced video feature data DS is based, thereby letting the succeeding reproduced video feature data DS be the representative feature data DSr.

Generally, animation content, such as imaged data, is made up of blocks of similar images. Therefore, by detecting a scene change, the representative image selecting block 33 can set the reproduced video feature data DS extracted from the image representative of each block as representative feature data DSr.

When representative feature data DSr is supplied from the representative image selecting block 33, the identifier identifying block 34 matches the reproduced video feature data DS attached with feature information identifier Tid against the representative feature data DSr and identifies the feature information identifier Tid of the reproduced video feature data DS matching the representative feature data DSr as a feature information identifier Tid of the representative feature data DSr (hereafter referred to as a representative feature information identifier Tidr), transmitting this representative feature information identifier Tidr to the text attaching block 35 and the representative image selecting block 33.

When the reproduction of the recorded imaged data has been completed, the representative image selecting block 33 identifies the reproduced video feature data DS (hereafter referred to as representative image data PDr) from which the representative feature data DSr has been extracted by use of the representative feature information identifier Tidr, superimposes this representative image data PDr on the image data read from the ROM, not shown, to generate text input image data PDn, and transmits the generated text input image data PDn to the video signal processing circuit 14.

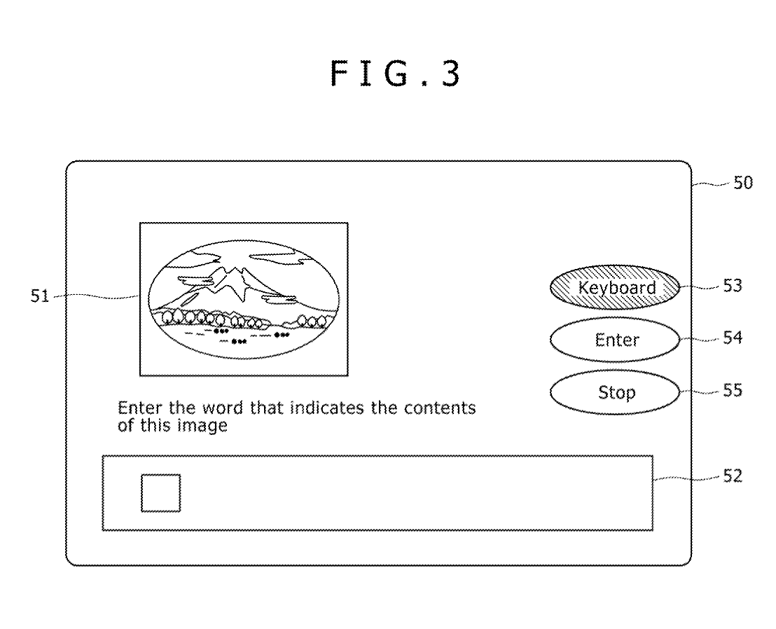

Consequently, as shown in FIG. 3, the hard disk recorder 1 can display a text input screen 50 on the display monitor, not shown.

On this text input screen 50, a representative image 51 based on representative image data PDr is displayed and, at the same time, a message “Enter the word that indicates the contents of this image”, for example, is displayed, thereby prompting the user to enter image text information TX corresponding to the representative image 51 into a text input box 52 shown in the bottom of the text input screen 50.

At this moment, on the text input screen 50, the cursor is positioned to a keyboard button 53 that is located on top of three buttons shown at the right side. The keyboard button pointed with the cursor is shown in a color different from that in which the other two buttons are shown.

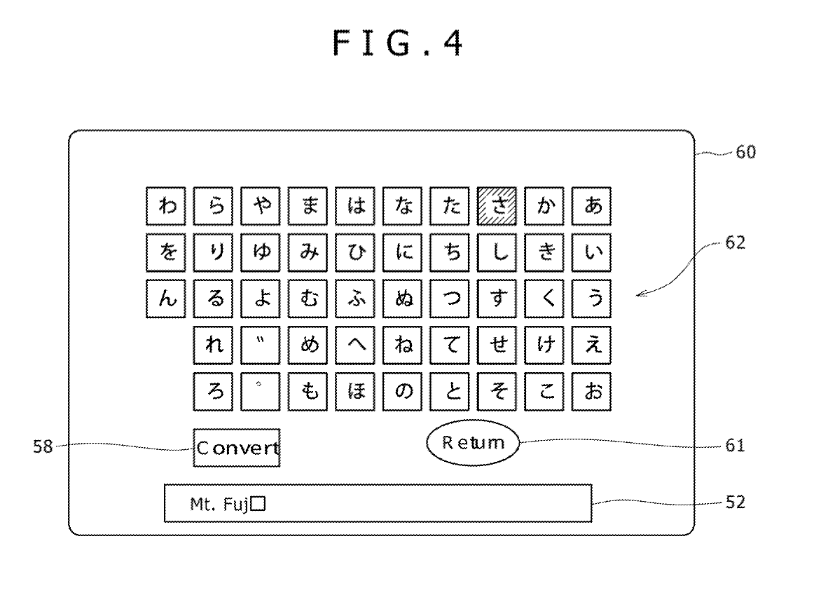

Pressing an enter button, not shown, of the remote controller 30 with the cursor positioned at the keyboard button 53 causes the representative image selecting block 33 to show a keyboard screen 60 on the display monitor on the basis of the image data read from the ROM, not shown, as shown in FIG. 4.

On the keyboard screen 60, the text input box 52 is shown at the bottom like on the text input screen 50 and, at the same time, the cursor is positioned at a return button 61 or a keyboard button group 62 in which hiragana characters are arranged according to Japanese syllabary.

The representative image selecting block 33 (FIG. 2) lets the user select necessary buttons in the keyboard button group 62 by use of cursor buttons and the enter button, both not shown, to enter the representative image 51 and the corresponding image text information TX.

Also, when the enter button of the remote controller 30 is pressed with the cursor positioned at the return button 61 on the keyboard screen 60, the representative image selecting block 33 displays the text input screen 50 (FIG. 3) on the display monitor again.

Then, when a cursor button, not shown, of the remote controller 30 is pressed to supply a corresponding operation signal from the remote controller interface 10, the representative image selecting block 33 moves the cursor from the keyboard button 53 to an enter button 54 and a stop button 55 sequentially.

When the enter button, not shown, of the remote controller 30 (FIG. 1) is pressed with the cursor positioned at the enter button 54, the controller 2 (FIG. 2) supplies the entered image text information TX to a text attaching block 35.

The text attaching block 35 registers the image text information TX entered by the user and the representative feature information identifier Tidr supplied from the identifier identifying block 34 to the image text database 42 (FIG. 2) of the flash memory 5.

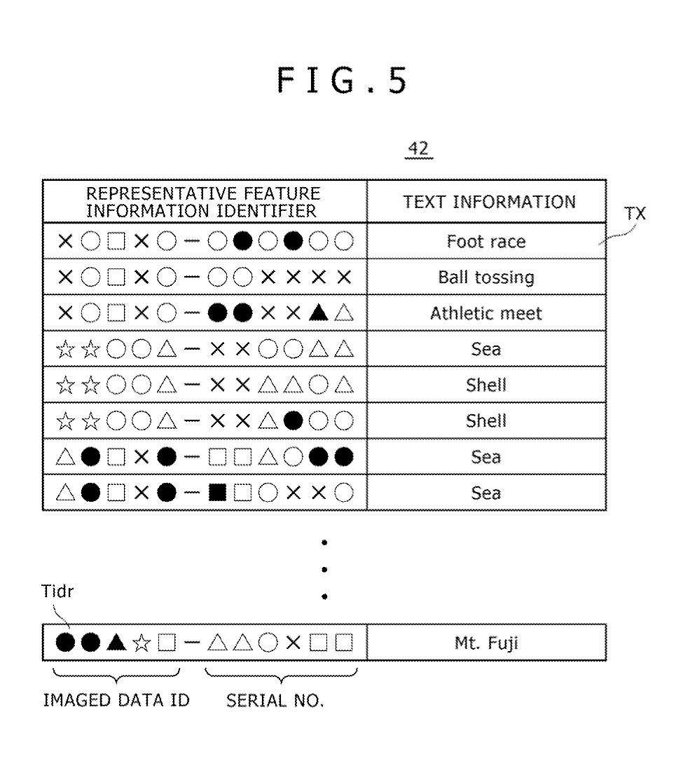

Consequently, as shown in FIG. 5, the controller 2 can generate the image text database 42 with which the representative feature information identifier Tidr and the image text information TX are registered as related with each other. By use of this generated image text database 42, the controller 2 can get the contents character information corresponding to given video content by use of the feature information extracted from that video content through the same extraction method as used in the database generating processing.

On the other hand, if the enter button, not shown, of the remote controller 30 is pressed with the cursor positioned at the stop button 55 (FIG. 3), then the controller 2 stops the database generating processing.

Consequently, the hard disk recorder 1 can determine whether to execute the database generating processing in accordance with user's state of mind, so that the hard disk recorder 1 can prevent the user from feeling that the input of image text information TX is bothering, without forcing the input of image text information TX.

It should be noted that, of reproduced video feature data DS, the image analysis block 31 extracts the reproduced video feature data DS that corresponds to an image easily responding to the text information such as of person or object, for example, thereby selecting representative feature data DSr from the selected reproduced video feature data DS. In this case, of the representative image 51, the image analysis block 31 displays only an area corresponding to person or object brighter than the surrounding, thereby letting the user easily understanding the inputting of the contents corresponding to that person or object to let the user correctly input the image text information TX indicative of the contents of the representative image 51.

Thus, the hard disk recorder 1 extracts reproduced video feature data DS from a reproduced video signal DP concurrently with reproducing processing to record the extracted reproduced video feature data DS to the feature data recording block 41 and, at the same time, selects representative image data DPr representative of each scene from that reproduced video feature data DS. Then, displays the representative image 51 based on the representative image data DPr onto the display monitor after the completion of the reproducing processing to let the user enter the image text information TX corresponding to the representative data DPr and, at the same time, registers the representative feature information identifier Tidr corresponding to the representative image data DPr and this image text information TX by relating each other, thereby generating the image text database 42 for obtaining the contents character information corresponding to the image.

### (3) Displaying Title Candidates

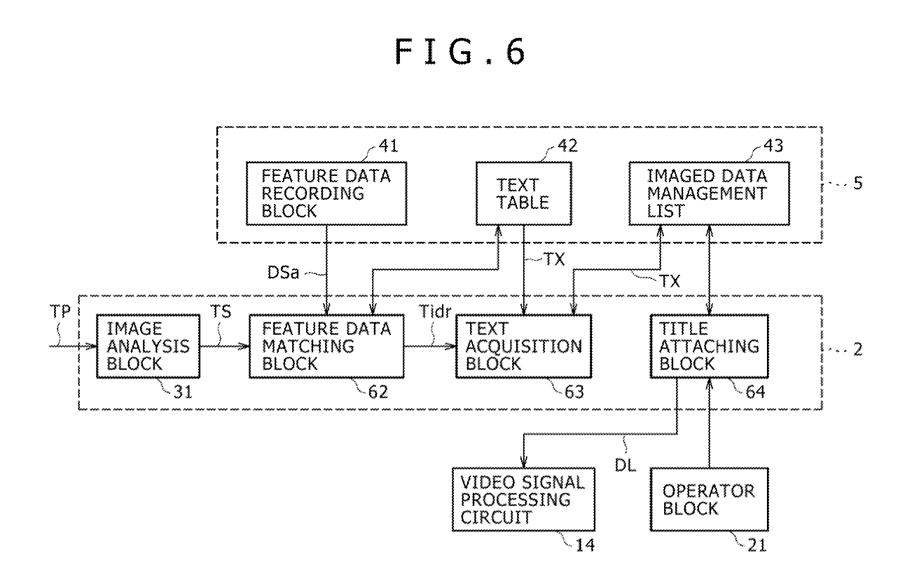

The following describes title candidate display processing (title candidate acquisition processing and list screen display processing) that is executed by use of the above-described image text database 42. In this title candidate display processing, the controller 2 of the hard disk recorder 1 executes a title candidate display program to realize the functional blocks shown in FIG. 6.

### (3-1) Acquiring Title Candidates

In recording input imaged data entered from an external device, such as a video camera, the controller 2 of the hard disk recorder 1 executes title candidate acquisition processing at the same time.

Namely, the controller 2 records input imaged data entered via the external interface 11 (FIG. 1) to the hard disk drive 4 and, at the same time, of the input imaged data, supplies an input video signal TP decoded by the video decoder 12 to the image analysis block 31.

The image analysis block 31 extracts input video feature data TS for each frame image from the input video signal TP by substantially the same processing as in the database generating processing and supplies the extracted input video feature data TS to a feature data matching block 62.

When the input video feature data TS is supplied, the feature data matching block 62 selects accumulated feature data DSa having a minimum distance relative of the input video feature data TS of the accumulated feature data DSa to which the image text information TX is related.

To be more specific, the feature data matching block 62 matches the accumulated feature data DSa to which image text information TX is related against input video feature data TS to detect 20 pieces, for example, of accumulated feature data DSa in the ascending order the distance from the input video feature data TS. Then, the feature data matching block 62 determines whether the detected accumulated feature data DSa is registered in the image text database 42 or not.

The feature data matching block 62 matches the feature information identifier Tid of the detected accumulated feature data DSa against the representative feature information identifier Tidr of the image text database 42. If the detected accumulated feature data DSa is found containing that registered in the image text database 42, the feature data matching block 62 selects, of the registered accumulated feature data DSa, the accumulated feature data DSa having the minimum distance from the input video feature data TS as minimum accumulated feature data DSan.

Further, the feature data matching block 62 determines whether the distance between the minimum accumulated feature data DSan and the input video feature data TS is below a predetermined similarity threshold value. If this distance is found to be below the predetermined similarity threshold value, the feature data matching block 62 determines that a frame image based on the input video feature data TS is similar to a frame image based on the minimum accumulated feature data DSan, thereby transmitting the representative feature information identifier Tidr owned by this minimum accumulated feature data DSan to a text acquisition block 63.

Upon acquiring the image text information TX corresponding to the representative feature information identifier Tidr from the image text database 42, the text acquisition block 63 temporarily stores the acquired image text information TX into the RAM, not shown, as contents character information TXc and, at the same time, ends the processing of the current input video feature data TS, thereby starting the generation of the input video feature data TS based on a next input video signal TP. At this moment, if the same contents character information TXc has been acquired twice or more, the text acquisition block 63 counts the number of acquisition.

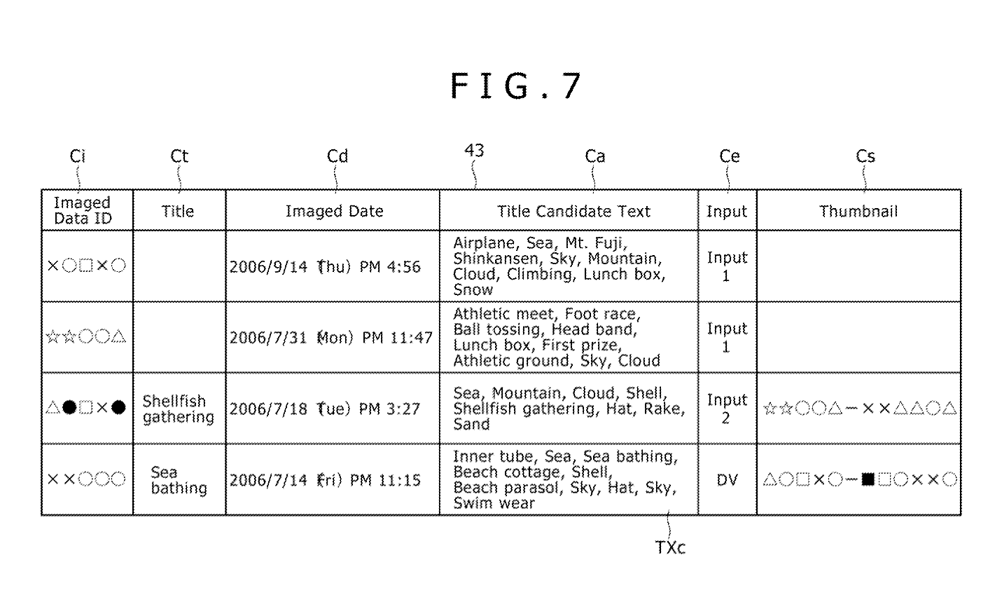

Then, when the controller 2 ends a sequence of processing for acquiring contents character information TXc for all the input video feature data TS owned by the input imaged data being recorded, the text acquisition block 63 selects, of the contents character information TXc temporarily stored in the RAM, 10 pieces, for example, of contents character information TXc in the descending order of the acquisition from the image text database 42, thereby registering the selected contents character information TXc into the imaged data management list 43 as shown in FIG. 7.

Consequently, the controller 2 selects the contents character information TXc indicative of a frame image that is comparatively long in the imaging time in input imaged data and high in the ratio of the imaging time to the input imaged data and, in order to make the selected contents character information TXc a title candidate text TI, registers, as the title candidate text TI, the contents character information TXc that is comparatively high in the indication of the contents of the recorded imaged data of which recording processing has been completed.

On the other hand, if, after matching the feature information identifier Tid of the detected accumulated feature data DSa against the representative feature information identifier Tidr of the image text database 42, no detected accumulated feature data DSa registered in the image text database 42 is found, then the feature data matching block 62 ends the processing of the current input video feature data TS, thereby starting the generation of the input video feature data TS based on a next input video signal TP.

If the feature data matching block 62 determines that the distance between minimum accumulated feature data DSan and input video feature data TS is in excess of a predetermined similarity threshold value, it indicates that the frame image based on the input video feature data TS is not similar to the frame image based on the minimum accumulated feature data DSan. Consequently, the feature data matching block 62 ends the processing of the current input video feature data TS and starts the generation of the input video feature data TS based on a next input video signal TP.

Thus, with the hard disk recorder 1, input video feature data TS is extracted from input video signal TP in the processing of recording imaged data; of the accumulated feature data DSa registered in the image text database 42, the minimum accumulated feature data DSan nearest to this input video feature data TS is identified; the image text information TX corresponding to the minimum accumulated feature data DSan is acquired as the contents character information TXc indicative of the contents of the frame image from which input video feature data TS is extracted; and that contents character information TXc is registered as the title candidate text TI indicative of the contents of the recorded imaged data.

Consequently, the hard disk recorder 1 can register the title candidate text TI indicative of the contents of the recorded imaged data into the imaged data management list 43 without having the user execute any operation therefor.

It should be noted that, in recording imaged data, the hard disk recorder 1 automatically register, in this imaged data management list 43 (FIG. 7), an imaged data ID, imaging date information attached to input imaged data, and input information indicative of which input terminal of the external interface 11 the imaged data has been entered through.

Further, because title candidate acquisition processing is executed concurrently with the recording of imaged data, the hard disk recorder 1 can register contents character information TXc into the imaged data management list 43 almost as the same time the recording of input imaged data ends.

Therefore, at the time when the recording of input imaged data has been completed, the imaged data management list 43 contains a blank title box Ct defined to register a title of imaged data and a blank thumbnail box Cs defined to register an image selected as a thumbnail image, and information-registered imaged data ID box Ci, imaging date information box Cd, title candidate box Ca, and input information box Ce.

### (3-2) Displaying an Imaged Data List Screen

When image data recording processing has been completed for all specified imaged data or when an operation signal requesting the displaying of an imaged data list screen 70 has been supplied from the remote controller interface 10 by the user through the remote controller 30, the controller 2 (FIG. 1) of the hard disk recorder 1 executes list screen display processing as instructed by a title candidate display program.

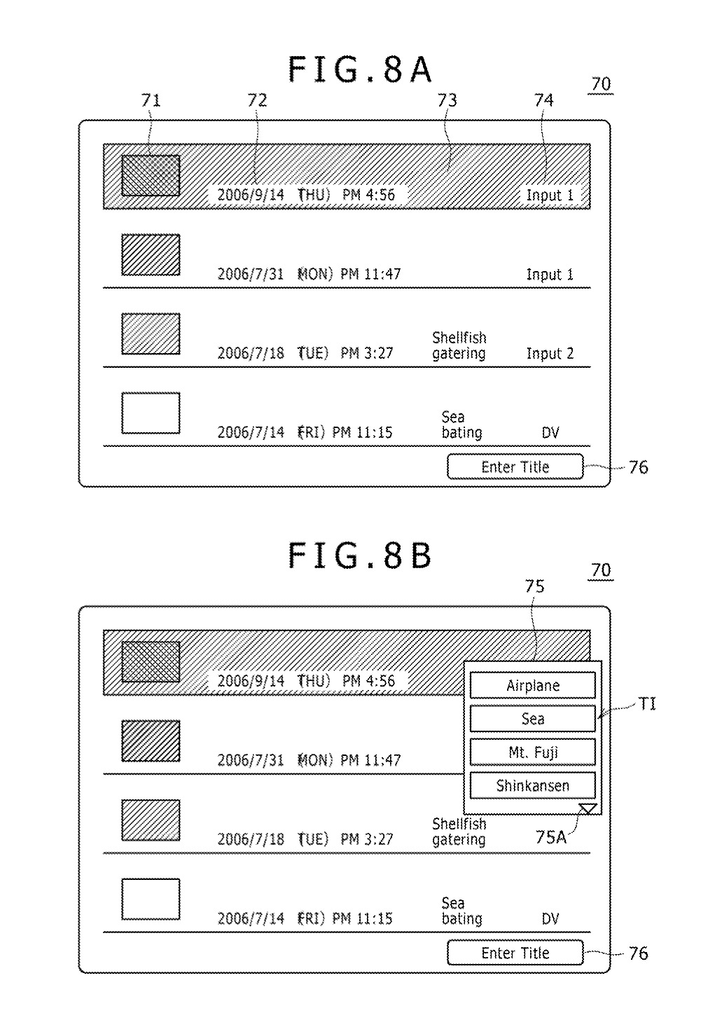

Namely, a title attaching block 64 (FIG. 6) of the controller 2 generates list image data DL on the basis of the imaged data management list 43 and transmits the generated data DL to the video signal processing circuit 14, thereby displaying the imaged data list screen 70 on the display monitor, not shown, as shown in FIG. 8.

The imaged data list screen 70 displays imaging date information and input information in an imaging date information display area 72 and an input information display area 73 respectively, on the basis of the imaged data management list 43.

If a title is registered in the imaged data management list 43 (FIG. 7), the input information display area 73 shows the title of recorded imaged data; if no title is registered, the input information display area 73 is left blank.

Positioning the cursor to the recorded imaged data displayed at the top of the imaged data list screen 70, the title attaching block 64 changes the color of the surrounding of this recorded imaged data and then displays this data. When a cursor button, not shown, of the remote controller 30 (FIG. 1) is operated by the user to supply a corresponding operation signal from the remote controller 30, the title attaching block 64 sequentially moves the cursor down to the succeeding recorded imaged data.

When the enter button, not shown, of the remote controller 30 (FIG. 1) is operated with the cursor positioned at one piece of recorded imaged data, the title attaching block 64 (FIG. 6) displays the title candidate texts TI about the recorded imaged data at which the cursor is positioned as a sub screen 75 based on pull down menu and, at the same time, positions the cursor to one of the title candidate texts TI.

Also, the title attaching block 64 is configured to display title candidate texts TI from top of the sub menu 75 in the descending order of the number of times these texts have been acquired from the image text database 42 in title candidate acquisition processing.

Thus, the hard disk recorder 1 can display title candidate texts TI in the descending order of the number of times these texts have been acquired as the contents character information TXc corresponding to the contents of the frame image owned by recorded imaged data, namely, in the order in which these texts correspond to more images, thereby presenting to the user the title candidate texts TI higher in possibility of indicating the contents of the recorded imaged data. Therefore, this configuration allows the displaying of the text information indicative of the contents of recorded imaged data onto a display monitor without bothering to reproduce the recorded imaged data.

It should be noted that a triangle symbol shown in the lower right side of the sub menu 75 is indicative that there are more title candidate texts TI below in the sub menu 75. When the down cursor button of the remote controller 30 is operated, the title attaching block 64 scrolls down the sub menu 75 to display more title candidates.

Further, when the enter button of the remote controller 30 is pressed with the cursor positioned at one title candidate, “Mt. Fuji” for example, the title attaching block 64 registers title “Mt. Fuji” into the title box Ct of the imaged data management list 43 and, at the same time, displays title “Mt. Fuji” in a title display area 73 of the imaged data list screen 70.

Consequently, the hard disk recorder 1 can let the user determine a desired title by a simple operation of selecting from two or more title candidates, thereby registering titles into the imaged text database 42 without bothering the user with cumbersome operations.

For example, if “Mt. Fuji” is selected for a title, the title attaching block 64 selects an image corresponding to “Mt. Fuji” from among the recorded imaged data having the representative image 51 being displayed and displays the selected image in a thumbnail image display area 71.

Namely, if the representative feature information identifiers Tidr registered as related with “Mt. Fuji” on the basis of the recorded image data being displayed is found, the title attaching block 64 selects one of these identifiers from the image text database 42 to register the selected identifier into the thumbnail box Cs of the imaged data management list 43 and, at the same time, displays the image corresponding to the registered identifier into the thumbnail image display area 71 as a thumbnail image.

On the other hand, if no representative feature information identifier Tidr registered as related with “Mt. Fuji” on the basis of the recorded imaged data being displayed is found, the title attaching block 64 selects one representative feature information identifier Tidr related with “Mt. Fuji” on the basis of another recorded imaged data, detects the input video feature data TS most similar to the accumulated feature data DSa represented by this representative feature information identifier Tidr to identify the feature information identifier Tid of the detected input video feature data TS, registers the identified feature information identifier Tid into the thumbnail box Cs of the imaged data management list 43, and displays the image corresponding to this representative feature information identifier Tidr into the thumbnail image display area 71 as a thumbnail image.

Further, if no title is set in the imaged data management list 43 and no representative feature information identifier Tidr is registered in the thumbnail box Cs, then the title attaching block 64 displays a given image (an image of the first frame for example) in the recorded image data into the thumbnail image display area 71.

Consequently, the title attaching block 64 can display, as a thumbnail image, the representative image data PDr corresponding to the title selected by the user as indicative of the contents of imaged data, thereby displaying the image indicative of the contents of image data into the thumbnail image display area 71.

In addition, when the enter button of the remote controller 30 is pressed with the cursor positioned at a title input button 76, the title attaching block 64 displays the keyboard screen 60 (FIG. 4) to let the user enter a desired title.

Consequently, the title attaching block 64 can enter any title of user preference with reference to the title candidate text TI being displayed and, at the same time, set a title of user preference to the recorded imaged data if the displayed title candidate text TI is rejected by the user.

Thus, the hard disk recorder 1 is configured, in displaying the imaged data list screen, to display the title candidate texts TI registered by the title candidate acquisition processing onto the sub menu 75, thereby letting the user select a desired title from among these title candidate texts TI.

Consequently, the hard disk recorder 1 can let the user determine a desired title of recorded image data with a simple operation of selection from among the displayed title candidate texts TI, thereby simplifying the job of entering titles into the imaged data management list 43.

### (4) Procedure of Generating an Image Text Database

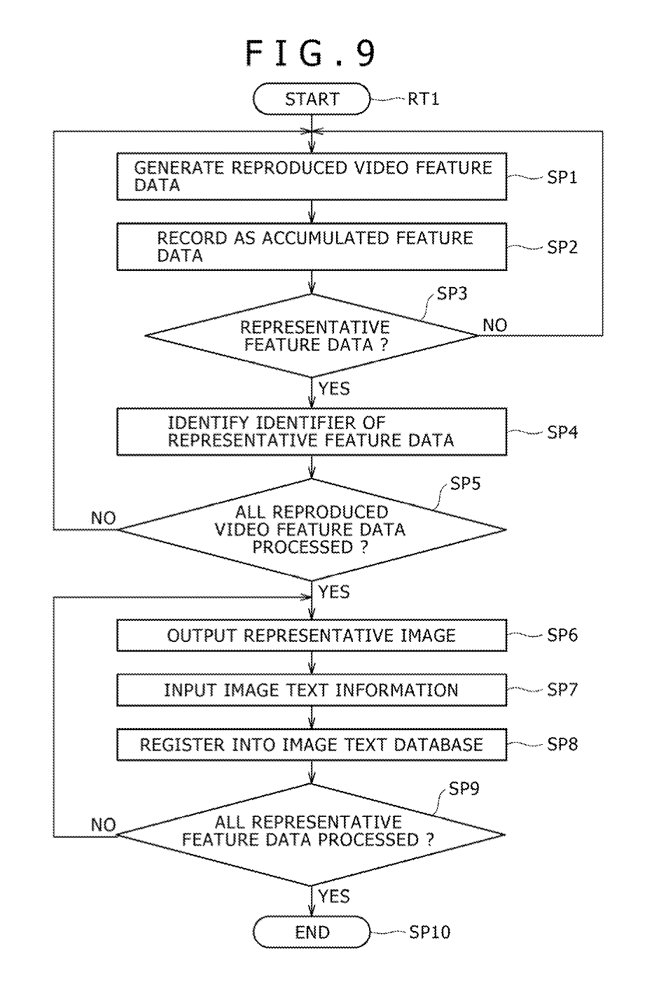

The following describes a database generating procedure that is executed as instructed by a database generating program, with reference to the flowchart shown in FIG. 9.

When the reproduction of the recorded imaged data recorded to the hard disk drive 4 is started by the user through the remote controller 30 (FIG. 1), the controller 2 of the hard disk recorder 1 enters the start step of a database generating procedure RT1 and then goes to step SP1, in which reproduced video feature data DS is generated on the basis of a reproduced video signal DP supplied from the video decoder 12, upon which the procedure goes to step SP2.

In step SP2, the controller 2 attaches a feature information identifier Tid to reproduced video feature data DS and records the reproduced video feature data DS and feature information identifier Tid to the feature data recording block 41 (FIG. 2), upon which the procedure goes to step SP3.

In step SP3, the controller 2 determines whether the supplied reproduced video feature data DS is representative feature data DSr in accordance where there is any scene change for example. If the determination is in the negative, the procedure returns to step SP1, starting the processing of next reproduced video feature data DS.

If the determination in step SP3 is in the affirmative, then the procedure goes to step SP4, in which the controller 2 identifies the representative feature information identifier Tidr of representative feature data DSr and temporarily stores the representative feature information identifier Tidr into the RAM, not shown, upon which the procedure goes to step SP5.

In step SP5, the controller 2 determines whether the processing of all reproduced video signal DP in the reproduced recorded imaged data has been completed. If the determination is in the negative, then the procedure returns to step SP1, in which the controller 2 starts the processing of next reproduced video signal DP.

On the other hand, if the determination in step SP5 is in the affirmative, it indicates that the recorded imaged data reproducing processing has been completed, upon which the procedure goes to step SP6.

In step SP6, the controller 2 identifies representative data DPr by use of the representative feature information identifier Tidr recorded to the RAM and displays the text input screen 50 (FIG. 3) containing the representative image 51 based on the identified representative data DPr onto the display monitor, not shown, upon which the procedure goes to step SP7.

When image text information TX is entered by the user in step SP7, the procedure goes to step SP8.

In step SP8, the controller 2 relates the image text information TX entered in step SP7 with the representative feature information identifier Tidr and registers these information and identifier into the image text database 42 (FIG. 5), upon which the procedure goes to step SP9.

In step SP9, the controller 2 determines whether the processing of all representative feature data DSr recorded to the RAM has been completed. If the determination is in the negative, the procedure returns to step SP6, in which the controller 2 starts the processing of next representative feature data DSr.

On the other hand, if the response in step SP9 is in the affirmative, then the procedure goes to step SP10, in which the controller 2 ends the above-mentioned processing.

It should be noted that the controller 2 is configured to execute this database generating processing only once for each piece of recorded imaged data. Therefore, if the imaged data reproduction processing is to be executed on recorded imaged data two or more times, the database generating processing is not executed in the second and subsequent imaged data reproduction processing.

If, during the execution of the second or subsequent reproduction processing on recorded imaged data, an operation signal requesting the input of the image text information TX corresponding to an image being displayed, the controller 2 uses the screen being displayed as a representative image, thereby executing the processing of steps SP6 through SP10.

In this case, the controller 2 need not extract reproduced video feature data from the image data being displayed. Therefore, the controller 2 may identify the feature information identifier Tid corresponding to the image data being displayed in step SP8, using the identified identifier as the representative feature information identifier Tidr.

### (5) Procedure of Title Candidate Display Processing

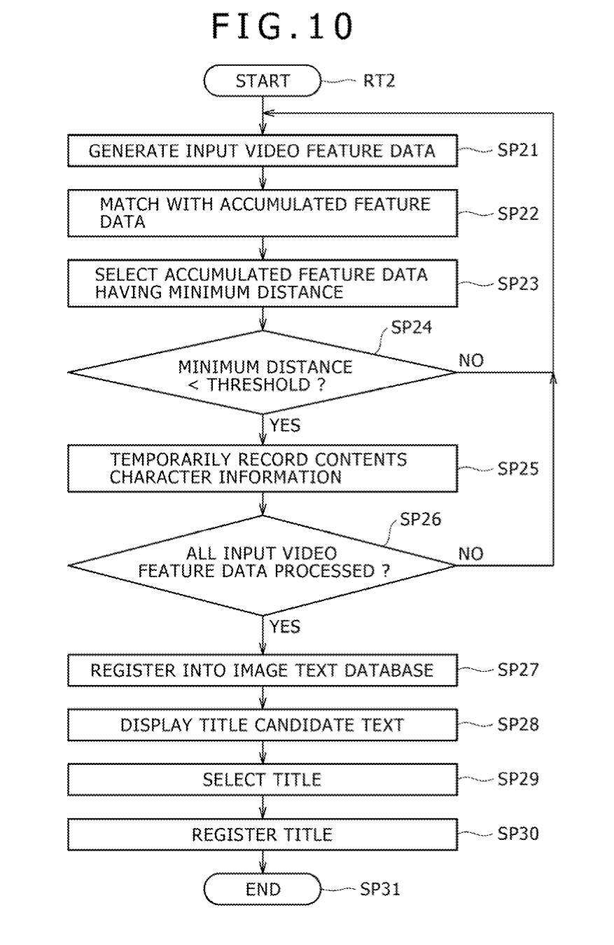

The following describes a procedure of title candidate display processing to be executed as instructed by the database generating program, with reference to the flowchart shown in FIG. 10.

When the processing of recording the input image data entered from an external device such as a video camera, not shown, connected to the external interface 11 is started by the user through the remote controller 30 (FIG. 1), the controller 2 of the hard disk recorder 1 enters the start step of a title candidate processing procedure RT2, upon which the procedure goes to step SP21. In step SP21, the controller 2 generates input video feature data TS on the basis of an input video signal TP supplied from the video decoder 12, upon which the procedure goes to step SP22.

In step SP22, the controller 2 matches the input video feature data TS generated in step SP21 against the accumulated feature data DSa recorded to the feature data recording block 41 (FIG. 6) of the flash memory 5, upon which the procedure goes to step SP23. In step SP23, the controller 2 selects, from the accumulated feature data DSa, the minimum accumulated feature data DSan that is registered in the image text database 42 and has the shortest distance from the input video feature data TS, namely, the minimum distance, upon which the procedure goes to step SP24.

In step SP24, the controller 2 determines whether the minimum distance is below a predetermined similarity threshold value.

If the determination in step SP24 is in the negative, it indicates that there is no similarity between the minimum accumulated feature data DSan having the minimum distance and the input video feature data TS, upon which the procedure returns to step SP21, in which the controller 2 starts the processing of next input video signal TP.

On the other hand, if the determination of step SP24 is in the affirmative, then it indicates that there is a similarity between the minimum accumulated feature data DSan and the input video feature data TS, upon which the procedure goes to step SP25.

In step SP25, the controller 2 gets the contents character information TXc corresponding to the minimum accumulated feature data DSan from the image text database 42 and temporarily stores the acquired information into the RAM, not shown, as the contents character information TXc corresponding to the input video signal TP, upon which the procedure goes to step SP26.

In step SP26, the controller 2 determines whether the processing of all input video signals TP has been completed. If the determination is in the negative, the procedure returns to step SP21, in which the controller 2 starts the processing of a next input video signal TP.

On the other hand, if the determination in step SP26 is in the affirmative, it indicates that the processing of recording the input imaged data has been completed, upon which the procedure goes to step SP27.

In step SP27, the controller 2 checks the number of times contents character information TXc has been acquired, selects 10 pieces, for example, of contents character information TXc in the descending order of the acquisition as title candidate text TI, and registers the selected title candidate text TI into the imaged data management list 43 (FIG. 7), upon which the procedure goes to step SP28.

In step SP28, the controller 2 displays the imaged data list screen 70 (FIG. 8) that is a list of recorded imaged data onto the display monitor, not shown, on the basis of the imaged data management list 43, upon which the procedure goes to step SP29. At this moment, the controller 2 displays the title candidate text TI on a sub screen 75A as instructed by the user.

In step SP29, when a title of the recorded imaged data has been selected by the user, the procedure goes to step SP30.

In step SP30, the controller 2 registers the title registered in step SP30 into the imaged text database 42 (FIG. 7), upon which the procedure goes to step SP31, in which the controller 2 ends the above-mentioned processing.

It should be noted that, if an operation signal indicative of displaying the imaged data list screen 70 (FIG. 8) is supplied from the remote controller interface 10 by the user through the remote controller 30, then the controller 2 executes the list screen display processing of steps SP28 through SP31. It is also practicable for the controller 2 to execute, in the input image data recording processing, only the title candidate acquisition processing of steps SP21 through SP27 and go to step SP31 by skipping the list screen display processing.

### (6) Operations and Effects

In the above-described configuration, the hard disk recorder 1 extracts input video feature data TS that is the content feature information indicative of a feature of each image from this image making up input image data that is video content in accordance with a predetermined feature extraction algorithm based on luminance and detects accumulated feature data DSa similar to the input video feature data TS from the image text database 42 in which the representative feature data DSr extracted from the representative image data PDr that is a given image in the same extraction method as that of the input video feature data TS and the image text information TX indicative of the contents of the representative image data PDr are registered as related with each other. Further, as the contents character information TXc indicative of the contents of an image (or an input video signal TS) from which input video feature data TS is extracted, the hard disk recorder 1 acquires the image text information TX corresponding to the detected accumulated feature data DSa from the image text database 42.

Consequently, in the above-mentioned configuration, the relationship with the similar minimum accumulated feature data DSan indicates the contents of each image owned by input imaged data, so that the hard disk recorder 1 can automatically acquire the contents character information TXc high in the possibility of indicating the contents of the input imaged data without bothering the user with any operation.

Further, the hard disk recorder 1 detects the minimum accumulated feature data DSan most similar to input video feature data TS from the image text database 42 to acquire the contents character information TXc corresponding to this minimum accumulated feature data DSan, thereby selectively acquiring the image text information TX higher in the possibility of indicating the contents of each image based on the input video feature signal TS as the contents character information TXc.

Still further, in recording input imaged data supplied from an external device such as a video camera through the external interface 11, the hard disk recorder 1 extracts input video feature data TS from each frame image making up this input imaged data to execute title candidate acquisition processing, thereby acquiring he contents character information TXc upon the ending of the input imaged data recording processing. Therefore, for recorded imaged data, the hard disk recorder 1 can always use this contents character information TXc anytime.

In addition, by registering contents character information TXc into the imaged data management list 43, the hard disk recorder 1 can display this contents character information TXc as a candidate of the title of recorded image data and use this contents character information TXc a keyword for searching for the contents of recorded imaged data, thereby enhancing user convenience.

In the above-described configuration, contents character information TXc is registered in the imaged data management list 43 by a predetermined amount (ten pieces for example) in the descending order of the number of times of acquisition, so that a large number of images owned by recorded imaged data correctly indicates the contents of the recorded imaged data, thereby allowing the hard disk recorder 1 selectively to register the contents character information TXc into the imaged data management list 43 in the descending order in which the possibility is higher of the suitability as titles and keywords of the recorded imaged data.

Further, the hard disk recorder 1 can display the contents character information TXc registered in the imaged data management list 43 onto the display monitor as the title candidate text TI that is a candidate of the title indicative of the contents of recorded imaged data to let the user recognize the contents of this recorded imaged data without reproducing this recorded imaged data, thereby allowing the user to remember or predict the contents of recorded imaged data.

Still further, the hard disk recorder 1 can let the user select one title candidate text TI from the displayed title candidate texts TI and, at the same time, register the selected title candidate text TI into the imaged data management list 43 as the title of the recorded imaged data, thereby allowing the user to set desired titles to recorded imaged data only by selecting one of the displayed title candidate texts TI, without bothering the user with the determination of titles and cumbersome input operations.

In addition, the hard disk recorder 1 can acquire contents character information TXc from the image text database 42 generated by the database generating processing in which the user himself sets the image text information TX corresponding to the representative image 51, thereby allowing the acquisition of the image text information TX registered according to user preference as contents character information TXc.

In this case, persons who took input imaged data are limited, so that, unlike the use of the image text database 42 generated by unspecified users, the reproduced video feature data DS and the image text information TX based on images that are similar to each other in line are registered in the image text database 42, thereby allowing the hard disk recorder 1 to significantly enhance the probability in which the acquired contents character information TXc is indicative of the contents of each image based on input video feature data TS.

As described and according to the above-described configuration, the hard disk recorder 1 can acquire the image text information TX corresponding to the representative image data DPr similar to an image owned by input imaged data from the image text database 42 in which representative feature data DSr extracted from given video content and the image text information TX indicative of the contents of the representative image data DPr on-which this representative feature data DSr is based are related with each other, as contents character information TXc indicative of the contents of an image owned by that imaged data, thereby realizing a contents character information acquisition method, a contents character information acquisition program, a contents character information acquisition apparatus, and a video content recording apparatus that are configured to acquire the contents character information TXc indicative of the contents of input imaged data.

### (7) Other Embodiments

In the above-described embodiment of the invention, input video feature data TS is matched against all accumulated feature data DSa to detect the accumulated feature data DSa that is below a predetermined similarity threshold value and whether or not the detected accumulated feature data DSa is registered in the image text database 42 is determined to detect the accumulated feature data DSa that is registered in the image text database 42 and similar to the input video feature data TS. However, it is also practicable to match input video feature data TS only against the accumulated feature data DSa registered in the image text database 42 to determine the accumulated feature data DSa that is below the similarity threshold value, thereby detecting the similar accumulated feature data DSa.

In the above-described embodiment, ten pieces that is a predetermined number of registrations of contents character information TXc are selected from the acquired contents character information TXc to be registered in the imaged data management list 43. However, it is also practicable to register all the acquired contents character information TXc into the imaged data management list 43.

Further, in the above-described embodiment, the number of times contents character information TXc has been acquired is counted to register the contents character information TXc into the imaged data management list 43 in the descending order of the acquisition count. However, it is also practicable to register contents character information TXc in the order of acquisition or in the descending order of correlation values at the time of matching, for example.

In registering contents character information TXc in the descending order of correlation values, the feature data matching block 62 computes these correlation values and temporarily stores the computed values in the RAM when matching input video feature data TS against accumulated feature data DSa. Then, the text acquisition block 63 registers contents character information TXc into the imaged data management list 43 by starting with one corresponding to the accumulated feature data DSa that is high in correlation value. Consequently, the controller 2 can register the contents character information TXc that is higher in the possibility of correctly indicative of the contents of each image represented by an input video signal TP into the imaged data management list 43 with preference.

Also, it is practicable for the controller 2 to compute a multiplication value obtained by multiplying an acquisition count by a correlation coefficient in accordance with a correlation value and a sum of multiplication values for each contents character information TXc, thereby registering the contents character information TXc into the imaged data management list 43 in the descending order of the sums of multiplication values. Consequently, by considering both the acquisition count of contents character information TXc and the correlation value between input video feature data TS and accumulated feature data DSa, the controller 2 can register the correct contents character information TXc for each image into the imaged data management list 43 in a proper priority order in accordance with the ratio of images owned by recorded imaged data.

Further, in the above-described embodiment, of the similar accumulated feature data DSa, only one piece of contents character information TXc corresponding to the minimum accumulated feature data DSan is registered in the imaged data management list 43. However, it is also practicable to register two or more pieces of contents character information TXc.

In the above-described embodiment, it is determined that the image corresponding to the minimum accumulated feature data DSan having a minimum distance from input video feature data TS is most similar to recorded video data TP. However, it is also practicable to determine that the image corresponding to the accumulated feature data DSa highest in correlation value with the input video feature data TS, for example, is most similar to the input video signal TP.

In the above-described embodiment, in entering image text information TX into a displayed image in response to a user request, the accumulated feature data DSa recorded to the feature data recording block 41 is used. However, it is also practicable to use accumulated feature data DSa for a variety of processing operations, such as the selection of a portion to be reproduced in digest reproduction, for example.

In the above-described embodiment, feature information identifier Tid made up of imaged data ID and serial number is attached to reproduced video feature data DS. However, it is also practicable to use any other methods of attaching feature information identifier Tid as long as recorded imaged data and feature information identifier Tid are related with each other.

In the above-described embodiment, contents character information TXc is registered in the imaged data management list 43 as title candidate text TI that provides a title candidate. However, it is also practicable to register contents character information TXc as a search keyword, for example.

In the above-described embodiment, input video feature data TS is generated from input imaged data for each frame image. However, it is also practicable to generate input video feature data TS for each field image, for example.

In the above-mentioned embodiment, input video feature data TS is generated from all frame images of input imaged data. However, it is also practicable to generate input video feature data TS for every several frames, for example.

In the above-described embodiment, if no title is registered in the title box Ct of the imaged data management list 43, the title display box 73 of the imaged data list screen 70 is left blank. However, it is also practicable to show title candidate text TI first registered in the imaged data management list 43 into the title display box 73, for example.

Consequently, the hard disk recorder 1 can display title candidate text TI indicative of the contents of recorded imaged data to let the user visually recognize the contents of the recorded imaged data without having the user select one piece of the recorded imaged data and display the selected data onto the sub menu 75.

Further, in the above-described embodiment of the invention, of the displayed imaged data, only an image corresponding to a user-selected title is displayed in the thumbnail image display area 71. However, it is also practicable to select an image corresponding to a title from other imaged data not displayed and display the selected image.

In the above-described embodiment, in selecting an image to be displayed in the thumbnail image display area 71, if the representative feature information identifier Tidr corresponding to a user-selected title is not registered in the imaged data management list 43, the input video feature data TS that is most similar to one piece of representative feature data DSr corresponding to the title is detected. However, it is also practicable to select, of the similar input video feature data TS, given input video feature data TS to display the selected input video feature data TS onto the thumbnail image display area 71.

In the above-described embodiment, an image based on the input video feature data TS corresponding to a selected title is displayed in the thumbnail image display area 71 as a thumbnail image. However, it is also practicable to always display the first frame image of recorded imaged data as a thumbnail image, for example. In addition, it is not always necessary to display a thumbnail image on the imaged data list screen 70.

In the above-described embodiment, the thumbnail image display area 71, the imaging date information display area 72, the title display area 73, and an input information display area 74 are arranged on the imaged data list screen 70. However, it is also practicable to appropriately change the items to be displayed on the imaged data list screen 70, in accordance with the items of the imaged data management list 43 to be automatically generated.

In the above-described embodiment, the image text database 42 is recorded to the flash memory 5. However, it is also practicable to record the image text database 42 to the hard disk drive 4, for example.

In the above-described embodiment, the hard disk recorder 1 executes database generating processing. However, it is also practicable for the hard disk recorder 1 to execute only the processing of acquiring contents character information TXc. In this case, the hard disk recorder 1 executes title display processing by use of the image text database 42 arranged as default and uses the image text database 42 shared via a network, for example.

In the above-described embodiment, the processing of acquiring contents character information TXc concurrently with the processing of recording input imaged data. However, it is also practicable to execute this acquisition processing along with reproduction processing or independently.

In the above-described embodiment, the image text database 42 is generated by database generating processing. However, it is also practicable to draw an image correctly indicative of the contents of arbitrarily selected image text information TX and use the image text database 42 in which the feature information extracted from this drawn image and image text information TX are related with each other.

In the above-described embodiment, input video feature data TS is extracted from the input imaged data taken by a video camera as video content. However, it is also practicable to extract content feature information from video content made up of various kinds of animation data, such as television broadcast programs and game software play screens, and still-image data, such as photographs, for example.

In the above-described embodiment, title candidate text TI is displayed for recorded imaged data. However, it is also practicable to display title candidate text TI for television broadcast programs. This configuration allows the hard disk recorder 1 to let the user select a user-preference title from the displayed title candidate text TI instead of an existing title attached to each television broadcast program, thereby allowing the setting of user-preference titles also to television broadcast programs by a simplified operation.

In the above-described embodiment, the hard disk recorder 1 having recording and reproduction capabilities executes database generating processing. However, substantially the same effects may be achieved when the database generating processing is executed by a computer having video content recording and reproducing capabilities, a recording apparatus having only recording capabilities, or a recording/reproducing apparatus having only recording and reproducing capabilities.

In the above-described embodiment, automatically distributed television broadcast programs and imaged data entered via the external interface 11 are recorded. However, it is also practicable to record video content downloaded from Internet sites, for example.

In the above-described embodiment, the database generating program and so on are stored in the ROM or hard disk drive 4 in advance. However, it is also practicable to install the database generating program and so on from an external storage media, such as Memory Stick (trademark of Sony Corporation), into the flash memory 5, for example. Alternatively, the database generating program and so on may be externally obtained via USB (Universal Serial Bus), Ethernet (trademark), IEEE (Institute of Electrical and Electronics Engineers) 802.11a/b/g wireless LAN (Local Area Network), for example, or distributed in the terrestrial digital television broadcasting or the BS digital television broadcasting, for example.

In the above-described embodiment, the hard disk recorder 1 has a contents character information acquisition apparatus made up of the image analysis block 31 as a feature information extracting block, the feature data matching block 62 as a given-image feature information detecting block, and the text acquisition block 63 as a text acquisition block. However, it is also practicable to configure the contents character information acquisition apparatus according to the invention by a feature information extracting block, a given-image feature information detecting block, and a text acquisition block of various other configurations.

The present invention is applicable to various kinds of information processing apparatuses configured to execute various processing operations, such as recording, reproducing, and editing of animation content, for example.

While preferred embodiments of the present invention have been described using specific terms, such description is for illustrative purpose only, and it is to be understood that changes and variations may be made without departing from the spirit or scope of the following claims.

It should be understood by those skilled in the art that various modifications, combinations, sub-combinations and alterations may occur depending on design requirements and other factors insofar as they are within the scope of the appended claims or the equivalents thereof.

What is claimed is:

1. A contents character information acquisition method comprising the steps of:
extracting content feature information indicative of an image making up video content in accordance with a predetermined extraction algorithm;
detecting, from a database in which given-image feature information extracted from a given image in accordance with said extraction algorithm is related with image text information indicative of contents of said given image, said given-image feature information that is similar to said content feature information; and
acquiring, as contents character information indicative of the contents of said image from which said content feature information has been extracted, said image text information related with said given-image feature information detected in the detection step from said database.

2. The contents character information acquisition method according to claim 1, wherein, in the detection step, of said given-image feature information similar to said content feature information, said given-image feature information that is most similar to said content feature information is detected.

3. The contents character information acquisition method according to claim 2, wherein, in the detection step, when said given-image feature information is represented as a vector, said given-image feature information having a minimum distance from a vector representative of said content feature information is detected as said given-image feature information that is most similar to said content feature information.

4. The contents character information acquisition method according to claim 1, wherein said video content is supplied from a predetermined external apparatus and recorded to a predetermined recorder and, in the extraction step, content feature information is extracted from said image making up said video content supplied from said external apparatus.

5. The contents character information acquisition method according to claim 1, further comprising the step of:
registering said contents character information into a management list configured to manage said video content.

6. The contents character information acquisition method according to claim 5, wherein, in the registration step, of said contents character information acquired in the acquisition step, said selected contents character information is registered into said management list by a predetermined number of registrations in a descending order of acquisition count.

7. The contents character information acquisition method according to claim 5, wherein, in the detection step, a correlation value between said detected given-image feature information and said content feature information is computed and, in the registration step, said contents character information acquired in the acquisition step is registered in said management list in a descending order of said correlation value.

8. The contents character information acquisition method according to claim 5, further comprising the step of:
displaying said contents character information registered in said management list onto a display apparatus as a candidate of a title indicative of contents of said video content.

9. The contents character information acquisition method according to claim 8, wherein, in the title candidate displaying step, a list screen on which said video content is displayed in a list is displayed and, if one piece of video content is selected by a user from among said video content displayed in a list, said contents character information corresponding to the selected one piece of video content is displayed on said display apparatus as said candidate.

10. The contents character information acquisition method according to claim 8, further comprising the steps of:
selecting one piece of said contents character information by the user from said contents character information displayed on said display apparatus; and
registering said one piece of contents character information selected in the selecting step into said management list as a title for said video content.

11. The contents character information acquisition method according to claim 10, wherein, in the title candidate displaying step, a list screen on which said video content is displayed in a list is displayed and, if said title is registered in said management list in the registration step, said title is displayed on said list screen and, if said title is not registered in said management list, one piece of contents character information selected in accordance with a predetermined selection algorithm is displayed as said title.

12. The contents character information acquisition method according to claim 11, wherein, in the title candidate displaying step, said contents character information most often acquired in the acquisition step is selected to provide said one piece of contents character information.

13. A contents character information acquisition program configured to make a computer executes the steps of:
extracting content feature information indicative of an image making up video content in accordance with a predetermined extraction algorithm;
detecting, from a database in which given-image feature information extracted from a given image in accordance with said extraction algorithm is related with image text information indicative of contents of said given image, said given-image feature information that is similar to said content feature information; and
acquiring, as contents character information indicative of the contents of said image from which said content feature information has been extracted, said image text information related with said given-image feature information detected in the detection step from said database.

14. A contents character information acquisition apparatus comprising:
a feature information extractor configured to extract content feature information indicative of an image making up video content in accordance with a predetermined extraction algorithm;
a feature information detector configured to detect, from a database in which given-image feature information extracted from a given image in accordance with said extraction algorithm is related with image text information indicative of contents of said given image, said given-image feature information that is similar to said content feature information; and
a text acquirer configured to acquire, as contents character information indicative of the contents of said image from which said content feature information has been extracted, said image text information related with said given-image feature information detected by the feature information detector from said database.

15. A video content recording apparatus comprising:
a recorder configured to record video content supplied from an external apparatus;
a feature information extractor configured to extract content feature information indicative of an image making up video content in accordance with a predetermined extraction algorithm;
a feature information detector configured to detect, from a database in which given-image feature information extracted from a given image in accordance with said extraction algorithm is related with image text information indicative of contents of said given image, said given-image feature information that is similar to said content feature information;
a text acquirer configured to acquire, as contents character information indicative of the contents of said image from which said content feature information has been extracted, said image text information related with said given-image feature information detected by said feature information detector from said database; and
a register configured to register said contents character information into a management list configured to manage said video content recorded to said recorder.
